(19) United States
(12) Patent Application Publication
(10) Pub. No.: US 2013/0101879 A1
(43) Pub. Date: Apr. 25, 2013

(54) ELECTRONIC DEVICE AND BATTERY CONNECTION MECHANISM THEREOF

(71) Applicants: CHANG-TER LEE, Tu-Cheng (TW); LIN YUAN, Shenzhen City (CN); MING-JUN SHI, Shenzhen City (CN)

(72) Inventors: CHANG-TER LEE, Tu-Cheng (TW); LIN YUAN, Shenzhen City (CN); MING-JUN SHI, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/300,673

(22) Filed: Nov. 21, 2011

(30) Foreign Application Priority Data
Oct. 19, 2011 (CN) 201110318405.6

(51) Int. Cl. H01M 2/10; H01M 2/02

(52) U.S. Cl. 429/100

(57) ABSTRACT

A battery connection mechanism an accommodating portion and a fixing portion. The accommodating portion defines a receiving space to tightly receive the battery therein. The accommodating portion includes a sidewall defining a plurality of perforations in two lines through the sidewall and a connecting portion being defined between the two lines of perforations. The fixing portion applied on the accommodating portion to affix the accommodating member to the casing of an electronic device. The connecting portion is to be peeled off along the perforations to let the battery be taken out of the accommodating portion.

### BACKGROUND

1. Technical Field

The present disclosure relates to electronic devices and battery connection mechanisms and, particularly, to an electronic device including a battery connection mechanism.

2. Description of Related Art

Due to the limited space, one common way to fix batteries to the casing of tablet computers is gluing. To perform maintenance on or replace the batteries, they have to be peeled off from the casing, which may damage the batteries.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure.

Moreover, in the drawings, like reference numerals designate corresponding parts throughout the several views.

FIG. 1 is a perspective, partial view of an electronic device with a battery connection mechanism in accordance with an exemplary embodiment.

FIG. 2 is an exploded perspective view of the electronic device shown in FIG. 1.

FIG. 3 is an explanatory view for showing a state of changing a battery in accordance with an exemplary embodiment.

### DETAILED DESCRIPTION

Embodiments of the present disclosure will now be described in detail, with reference to the accompanying drawings.

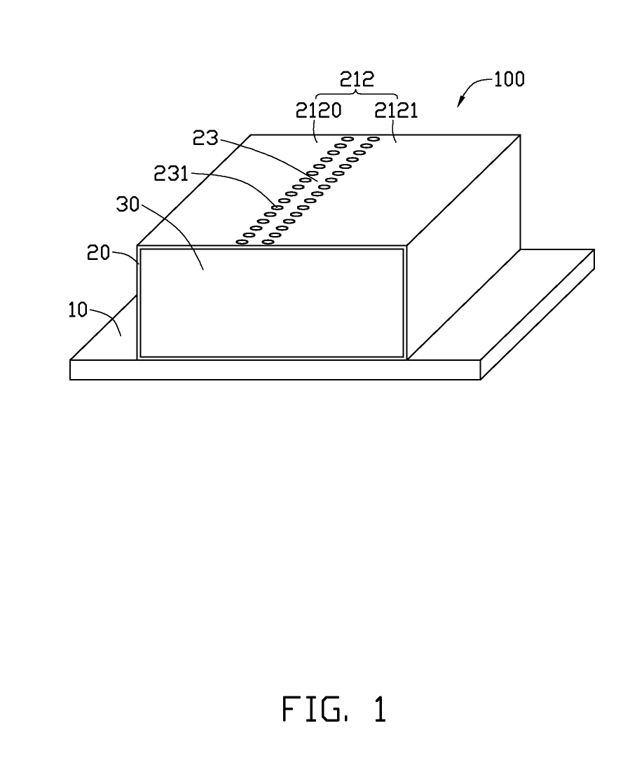

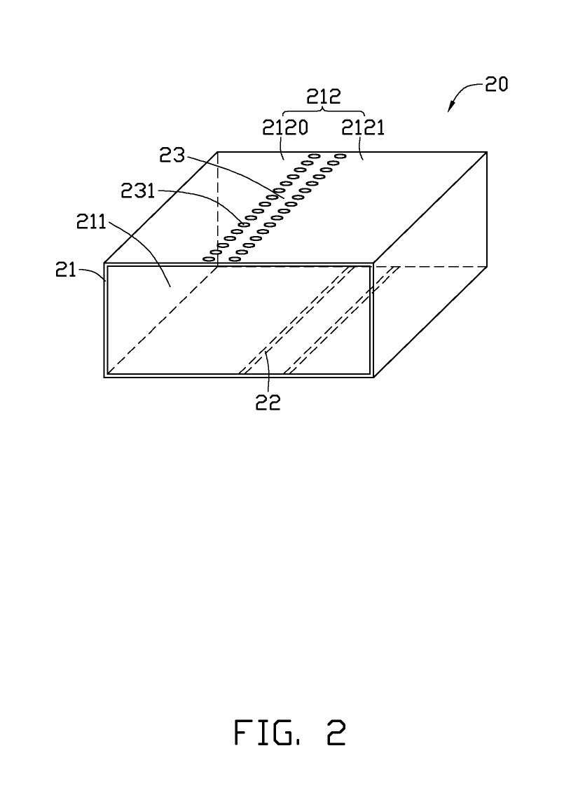

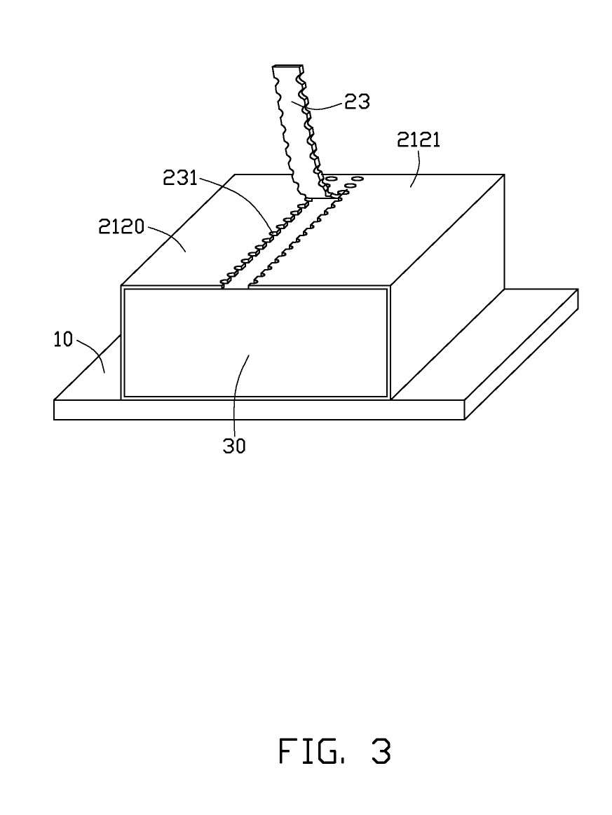

Referring to FIGS. 1-3, in an exemplary embodiment, an electronic device 100 includes a casing 10, a battery connection mechanism 20, and a battery 30. The battery 30 is fixed to the casing 10 by the battery connection mechanism 20 to supply power to the electronic device 100. In this embodiment, the electronic device 100 is a tablet computer.

The battery connection mechanism 20 includes an accommodating portion 21, a fixing portion 22, and a connecting portion 23. The accommodating portion 21 is hollow and defines a receiving space 211 to receive the battery 30. The receiving space 211 is sized in such a way that the battery 30 tightly fits in the receiving space 211. In this embodiment, the accommodating portion 21 is made of flexible material, such as plastic, thin metal sheet or the like. The accommodating portion 21 further defines at least one opening (not shown) to expose the electrodes (not shown) of the battery 30.

The fixing portion 22 is applied on the outer surface of the accommodating portion 21 and is used to affix the accommodating portion 21 to the casing 10. In this embodiment, the fixing portion 22 is adhesive. In an alternative embodiment, the fixing portion 22 may be a suction cup.

A sidewall 212 of the accommodating portion 21 includes a first half 2120 and a second half 2121. A number of perforations 231 are defined in two parallel lines through middle area of the sidewall 212, and space between the two lines forms the connecting portion 23.

The connecting portion 23 can be torn off along the perforations 231 to access the battery 30 if it needs servicing. The battery 30 can thus be easily removed without damage. Then the empty battery connection mechanism 20 can be pulled off from the electronic device 100 and a new one glued in place. In this embodiment, the perforations 231 are V-shaped for easy tearing. In alternative embodiments, the holes 231 may be X-shaped, Y-shaped, triangular, rhombic, square and the like. In other embodiments, the connecting portion 23 may be a fastener or a zipper.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A battery connection mechanism for use in an electronic device, the electronic device comprising a casing and a battery, the battery connection mechanism comprising:
an accommodating portion defining a receiving space to tightly receive the battery therein, the accommodating portion comprising a sidewall defining a plurality of perforations in two lines through the sidewall and a connecting portion being defined between the two lines of perforations; and
a fixing portion applied on the accommodating portion to affix the accommodating member to the casing,
wherein the connecting portion is configured to be peeled off along the perforations to let the battery be taken out of the accommodating portion.

2. The battery connection mechanism as described in claim 1, wherein the perforations are V-shaped, X-shaped, Y-shaped, triangular, rhombic, or square.

3. The battery connection mechanism as described in claim 1, wherein the accommodating portion is made of plastic.

4. The battery connection mechanism as described in claim 1, wherein the fixing portion is adhesive applied on outer surface of the accommodating portion.

5. The battery connection mechanism as described in claim 1, wherein the fixing portion is a suction cup.

6. The battery connection mechanism as described in claim 1, wherein the connection portion is a fastener or a zipper.

7. An electronic device comprising:
a casing;
a battery; and
a battery connection mechanism comprising:
an accommodating portion defining a receiving space to tightly receive the battery therein, the accommodating portion comprising a sidewall defining a plurality of perforations in two lines through the sidewall and a connecting portion being defined between the two lines of perforations; and
a fixing portion applied on the accommodating portion to affix the accommodating member to the casing,
wherein the connecting portion is configured to be peeled off along the perforations to let the battery be taken out of the accommodating portion.

8. The electronic device as described in claim 7, wherein the perforations are V-shaped, X-shaped, Y-shaped, triangular, rhombic, or square.

9. The electronic device as described in claim 7, wherein the accommodating portion is made of plastic.

10. The electronic device as described in claim 7, wherein the fixing portion is adhesives applied on outer surface of the accommodating portion.

11. The electronic device as described in claim 7, wherein the fixing portion is a suction cup.

12. The electronic device as described in claim 7, wherein the connection portion is a fastener or a zipper.
